(19) United States
(12) Patent Application Publication
(10) Pub. No.: US 2026/0071074 A1
(43) Pub. Date: Mar. 12, 2026

(54) COMPOSITE MATERIALS FOR USE IN CATHODE LAYERS AND METHODS OF MAKING THE SAME

(71) Applicant: Solid Power Operating, Inc., Louisville, CO (US)

(72) Inventors: Hong WANG, Northglenn, CO (US); Brian Clark, Broomfield, CO (US); Zichao Yang, Broomfield, CO (US); Anthony Donakowski, Golden, CO (US); Pu Zhang, Boulder, CO (US)

(21) Appl. No.: 19/325,138

(22) Filed: Sep. 10, 2025

Related U.S. Application Data
(60) Provisional application No. 63/693,107, filed on Sep. 10, 2024.

(51) Int. Cl. C09C 1/60

(52) U.S. Cl. CPC C09C 1/60; C01P 2004/03; C01P 2004/34; C01P 2004/61; C01P 2006/40

(57) ABSTRACT

Composite shell compositions for use in a cathode in a solid electrochemical cell are described. The composite shell compositions include sulfur, carbon, and a lubricant material. The composite shells improve the mechanical durability and the conductivity of the cathode.

### CROSS-REFERENCE TO RELATED APPLICATION

This application is related to and claims priority under 35 U.S.C. § 119 from U.S. Provisional Application No. 63/693,107 filed Sep. 10, 2024, titled “Composite Materials for Use in a Cathode Layers and Methods of Making the Same,” the entire contents of which are fully incorporated by reference herein for all purposes.

### STATEMENT REGARDING FEDERALLY SPONSORED RESEARCH

Some aspects of this invention may have been made with government support under Contract Number DE-AR0001727 awarded by the Advanced Research Projects Agency Energy. The government may thus have certain rights in the invention.

### FIELD OF THE DISCLOSURE

The present disclosure is directed toward materials used in electrode layers, such as cathode layers, of electrochemical cells, including solid-state electrochemical cells, and methods of making the same. Therefore, some aspects of the disclosure relate to the fields of batteries, including solid-state batteries, electronics, chemistry, and materials science.

### BACKGROUND AND INTRODUCTION

Conversion cathodes hold promise as providing higher energy density, among other advantages, in various battery types including solid state batteries. In contrast to an intercalation cathode where ions interact with the crystal structure during charging and discharging, conversion cathodes store energy through a conversion reaction. One practical challenge to employing a conversion cathode is that the cathode may undergo volume changes during cycling. These volume changes can negatively affect the contact between particles in the cathode, as well as contact between the cathode and adjacent cell layers, and may thus degrade electrode integrity and performance over time particularly as the cathode expands and contracts during successive charge and discharge cycles. Including materials such as binders can mitigate the negative impact of these volume changes, but the binder materials often can have low ionic conductivities and thus can still negatively impact cell performance and depress the potential advantages with conversion cathodes.

One need, among many, is a material with high ionic conductivity that can reduce and mitigate the negative impact of volume changes in conversion type cathodes. It is with these observations in mind, among others, that aspects of the present disclosure were conceived.

### SUMMARY

Provided herein are composite shell compositions for use in an electrochemical cell. The compositions generally comprise or consist of sulfur, carbon, and a lubricant, and have an average diameter from about 1 micron to about 50 microns. The composite shell compositions are generally substantially spheroidal in shape. The inside of the composite shell may be defined by a void; in other words, the composite shell may lack a core.

Further provided herein are composite shell compositions for use in an electrochemical cell. The compositions generally comprise or consist of sulfur and carbon, and have an average diameter from about 1 micron to about 50 microns. The composite shell compositions are generally substantially spheroidal in shape. The inside of the composite shell may be defined by a void; in other words, the composite shell may lack a core.

Further provided herein are cathode compositions that include the composite shell compositions described herein. The cathode compositions generally include a cathode active material and a composite shell composition as described herein. In some aspects, the cathode active material may include pyrite. Optionally, the cathode composition may also include a solid electrolyte material, a binder, a conductive additive, or a combination thereof.

Further provided herein is a process for making a composite shell composition as described herein. The process generally includes dry milling a mixture comprising sulfur, carbon, and a lubricant; and heat treating the mixture at a temperature from about 150° C. to about 170° C. to form the composite shell composition.

### BRIEF DESCRIPTION OF THE FIGURES

The present disclosure may be understood by reference to the following detailed description taken in conjunction with the drawings briefly described below. It is noted that, for purposes of illustrative clarity, certain elements in the drawings may not be drawn to scale.

FIG. 1 shows a scanning electron microgram of a composite shell of the present disclosure prepared using MoS₂ as a lubricant.

FIG. 2 shows a scanning electron microgram of a composite shell of the present disclosure prepared using graphite as a lubricant.

FIG. 3 shows a scanning electron microgram of a composite shell of the present disclosure prepared using only elemental sulfur and carbon black.

FIG. 4 shows a scanning electron microgram of a composite prepared without using a lubricant.

FIG. 5 shows a scanning electron microgram of a composite prepared by wet-milling and using MoS₂ as a lubricant.

### DETAILED DESCRIPTION

Before various aspects of the present invention are disclosed and described, it is to be understood that this invention is not limited to the particular methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity and in another example, a numerical range of “about 50 mg/mL to about 80 mg/mL” should also be understood to provide support for the range of “50 mg/mL to 80 mg/mL.”

In this disclosure, the terms “including,” “containing,” and/or “having” are understood to mean comprising, and are open ended terms.

Described herein are composite shell compositions for use in the cathode layers of electrochemical cells, including solid-state batteries. The composite shells are formed when carbon, sulfur, and a lubricant material are dry milled and then heat treated, as described in more detail further herein. Also described herein are cathode layers for use in electrochemical cells that include the composite shells. Also described herein are processes for making the composite shells.

### I. Composite Shell Compositions

Described herein are composite shells for use in the cathode layer of an electrochemical cell. When included in the cathode layer of an electrochemical cell, the composite shell may provide improved particle connectivity, improved mechanical stability of the cathode layer, and may limit the volume change in solid-state batteries with conversion pyrite cathodes. The carbon in the composite shells may further improve the electrical conductivity of the cathode layer.

The composite shells (also referred to herein as “hollow spheres”) have a substantially spherical shape, wherein an outer spheroidal shell defines a void inside of the composite shell. Stated another way, the composite shell lacks a core. As defined herein, “substantially spherical” refers to a shape that is approximately (not a uniform sphere) spherical or that has a generally round appearance. The composite shells described herein may be spherical, spheroidal, elliptical, ellipsoidal, lentoidal, ovoidal, cylindrical, etc.

As a conversion cathode goes through volume cycles during charge and discharge cycles of a battery including the cathode, it is believed that the hollow spheres may buffer those volumes changes, modestly contracting when volume is increasing and then expanding when volume is decreasing and thus absorbing some of the volume changes resulting in a comparatively lesser degree of volume changes. Buffering in this way may provide relatively more consistent and greater particle-to-particle contact during cycling, enhance contact and ensure consistent contact with adjacent battery cell layers, among other advantages. For an individual battery or a pack of batteries, reducing the degree of volume cycling can provide many implementation advantages.

Each composite shell may have an average diameter from about 1 micron to about 50 microns as measured by scanning electron microscopy, noting again that the hollow spheres are not uniform in shape and hence the diameter is not a uniform diameter. As used herein, “average diameter” may refer to the average diameter of a single composite shell or to the average diameter of a plurality of composite shells. The “average diameter” further refers to the outer diameter of the composite shell unless stated otherwise. Additionally, the hollow spheres may include one or more openings that expose the void space within the hollow sphere. Without wishing to be bound by theory, the openings may allow active materials to migrate into the void space within the hollow sphere during cycling and may improve the mixed electronic and ionic conductor network throughout the cathode.

The shell wall of the composite shell may have a thickness from about 0.5% to about 15% of the diameter of the shell. In other words, if the composite shell has an average diameter of, for example, about 10 microns, the shell wall of the composite shell may have a thickness from about 0.05 microns to about 1.5 microns. In some embodiments, the shell wall of the composite shell may have a thickness from about 0.5% to about 1%, about 0.5% to about 5%, about 0.5% to about 10%, about 0.5% to about 15%, about 1% to about 15%, about 5% to about 15%, about 10% to about 15%, or about 1% to about 10% of the average diameter of the composite shell.

For example, each composite shell may have an average diameter from about 1 micron to about 5 microns, about 1 micron to about 10 microns, about 1 micron to about 20 microns, about 1 micron to about 30 microns, about 1 micron to about 40 microns, about 1 micron to about 50 microns, about 5 microns to about 50 microns, about 10 microns to about 50 microns, about 20 microns to about 50 microns, about 30 microns to about 50 microns, about 40 microns to about 50 microns, about 5 microns to about 30 microns, about 5 microns to about 20 microns, about 5 microns to about 10 microns, about 10 microns to about 30 microns, or about 10 microns to about 20 microns as measured by scanning electron microscopy. As another example, each composite shell may have an average diameter of about 1 micron, about 2 microns, about 3 microns, about 4 microns, about 5 microns, about 6 microns, about 7 microns, about 8 microns, about 9 microns, about 10 microns, about 15 microns, about 20 microns, about 25 microns, about 30 microns, about 35 microns, about 40 microns, about 45 microns, or about 50 microns as measured by scanning electron microscopy.

As a further example, the composite shells in a cathode composition of the present disclosure may have an average diameter from about 1 micron to about 5 microns, about 1 micron to about 10 microns, about 1 micron to about 20 microns, about 1 micron to about 30 microns, about 1 micron to about 40 microns, about 1 micron to about 50 microns, about 5 microns to about 50 microns, about 10 microns to about 50 microns, about 20 microns to about 50 microns, about 30 microns to about 50 microns, about 40 microns to about 50 microns, about 5 microns to about 30 microns, about 5 microns to about 20 microns, about 5 microns to about 10 microns, about 10 microns to about 30 microns, or about 10 microns to about 20 microns as measured by scanning electron microscopy. As another example, the composite shells in a cathode composition of the present disclosure may have an average diameter of about 1 micron, about 2 microns, about 3 microns, about 4 microns, about 5 microns, about 6 microns, about 7 microns, about 8 microns, about 9 microns, about 10 microns, about 15 microns, about 20 microns, about 25 microns, about 30 microns, about 35 microns, about 40 microns, about 45 microns, or about 50 microns as measured by scanning electron microscopy.

The composite shells are formed from a composite material comprising or consisting of carbon, sulfur, and a lubricant. In some embodiments, the composite shells are formed from a composite comprising or consisting of carbon and sulfur. As used herein, a “composite” refers to a material that is made by physically combining two or more components to form the composite. Although generally the two or more components are combined only physically, chemical interactions between certain components may occur when forming the composite, thus forming new materials incorporated into the composite.

The carbon may be present in the composite shell composition in an amount from about 5% to about 50% by weight. For example, the carbon may be present in an amount from about 5% to about 10%, about 5% to about 20%, about 5% to about 30%, about 5% to about 40%, about 5% to about 50%, about 10% to about 50%, about 20% to about 50%, about 30% to about 50%, about 40% to about 50%, about 10% to about 30%, about 10% to about 40%, about 20% to about 30%, or about 20% to about 40% by weight of the composite shell composition. As another example, the carbon may be present in an amount of about 5%, about 10%, about 15%, about 20%, about 25%, about 30%, about 35%, about 40%, about 45%, or about 50% by weight of the composite shell composition.

The carbon may be formed from carbon particles having a surface area from about 100 m²/g to about 2000 m²/g. For example, the carbon particles may have a surface area from about 100 m²/g to about 250 m²/g, about 100 m²/g to about 500 m²/g, about 100 m²/g to about 750 m²/g, about 100 m²/g to about 1000 m²/g, about 100 m²/g to about 1250 m²/g, about 100 m²/g to about 1500 m²/g, about 100 m²/g to about 1750 m²/g, about 100 m²/g to about 2000 m²/g, about 250 m²/g to about 2000 m²/g, about 500 m²/g to about 2000 m²/g, about 750 m²/g to about 2000 m²/g, about 1000 m²/g to about 2000 m²/g, about 1250 m²/g to about 2000 m²/g, about 1500 m²/g to about 2000 m²/g, about 1750 m²/g to about 2000 m²/g, or about 500 m²/g to about 1500 m²/g. As another example, the carbon particles may have a surface area of about 100 m²/g, about 200 m²/g, about 300 m²/g, about 400 m²/g, about 500 m²/g, about 600 m²/g, about 700 m²/g, about 800 m²/g, about 900 m²/g, about 1000 m²/g, about 1100 m²/g, about 1200 m²/g, about 1300 m²/g, about 1400 m²/g, about 1500 m²/g, about 1600 m²/g, about 1700 m²/g, about 1800 m²/g, about 1900 m²/g, or about 2000 m²/g. In some embodiments, the carbon may comprise carbon black having a surface area from about 1400 m²/g to about 1600 m²/g.

The sulfur may be present in the composite shell composition in an amount from about 40% to about 90% by weight. For example, the sulfur may be present in the composite shell composition in an amount from about 40% to about 50%, about 40% to about 60%, about 40% to about 70%, about 40% to about 80%, about 40% to about 90%, about 50% to about 90%, about 60% to about 90%, about 70% to about 90%, about 80% to about 90%, or about 60% to about 80% by weight of the composite shell composition. As another example, the sulfur may be present in the composite shell composition in an amount of about 40%, about 45%, about 50%, about 55%, about 60%, about 65%, about 70%, about 75%, about 80%, about 85%, or about 90% by weight of the composite shell composition. The sulfur generally comprises elemental sulfur.

The lubricant, when present, may be present in the composite shell composition in an amount from about 1% to about 20% by weight. The lubricant may comprise one or more layer-lattice lubricants such as molybdenum disulfide (MoS₂), tungsten disulfide (WS₂), titanium disulfide (TiS₂), graphite, graphene, boron nitride (BN), talc (magnesium silicate), or any combination thereof. The lubricant may comprise other inorganic solid lubricants such as MXenes. The lubricant may comprise oxide-based ceramic lubricants (e.g., alumina-zirconia composites), borates, silicates, polyphosphates, metal oxide nanoparticles, phosphates, or a combination thereof. The lubricant may comprise metal-based lubricants such as tin, lead, zinc, copper, or alloys thereof, or any combination thereof.

For example, the lubricant may be present in the composite shell composition in an amount from about 1% to about 5%, about 1% to about 10%, about 1% to about 15%, about 1% to about 20%, about 5% to about 20%, about 10% to about 20%, about 15% to about 20%, or about 5% to about 15% by weight of the composite shell composition. As another example, the lubricant may be present in the composite shell composition in an amount of about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% by weight of the composite shell composition.

Those having ordinary skill in the art will recognize that the sulfur and some of the lubricant materials may also be used as a cathode active material in an cathode layer. Although the composite shells are not cathode active materials per se and without wishing to be bound by theory, the presence of these materials in the composite shell compositions may allow the composite shells to participate in the ionic conductivity of the cathode layer, in some examples.

In some embodiments, the composite shell composition does not include a binder.

### II. Process for Making the Composite Shell Composition

Further provided herein is a process for making the composite shell composition described in Section I above. In some embodiments, the process generally includes dry milling a mixture comprising or consisting of sulfur, carbon, and a lubricant, and heat treating the mixture at a temperature from about 150° C. to about 170° C. to form the composite shell composition. In some embodiments, the process generally includes dry milling a mixture comprising or consisting of sulfur and carbon and heat treating the mixture at a temperature from about 150° C. to about 170° C. to form the composite shell composition.

The first step of the process includes dry milling a mixture comprising or consisting of sulfur, carbon, and a lubricant. Alternatively, in some embodiments, the first step of the process may include dry milling a mixture comprising or consisting of sulfur and carbon. The sulfur may be elemental sulfur and may be present in the mixture in an amount from about 40% to about 90% by weight of the mixture. For example, the sulfur may be present in the mixture in an amount from about 40% to about 50%, about 40% to about 60%, about 40% to about 70%, about 40% to about 80%, about 40% to about 90%, about 50% to about 90%, about 60% to about 90%, about 70% to about 90%, about 80% to about 90%, or about 60% to about 80% by weight of the mixture. As another example, the sulfur may be present in the mixture in an amount of about 40%, 45%, 50%, 55%, 60%, 65%, 70%, 75%, 80%, 85%, or about 90% by weight of the mixture.

The carbon may be present in the mixture in an amount from about 5% to about 50% by weight of the mixture. Preferably, the carbon is a microporous carbon having a surface area from about 100 m²/g to about 2000 m²/g. In some embodiments, the carbon is carbon black. In some additional embodiments, the carbon is carbon black and has a surface area of about 1500 m²/g.

For example, the carbon may be present in the mixture in an amount from about 5% to about 10%, about 5% to about 20%, about 5% to about 30%, about 5% to about 40%, about 5% to about 50%, about 10% to about 50%, about 20% to about 50%, about 30% to about 50%, about 40% to about 50%, about 10% to about 30%, about 10% to about 40%, about 20% to about 30%, or about 20% to about 40% by weight of the mixture. As another example, the carbon may be present in an amount of about 5%, about 10%, about 15%, about 20%, about 25%, about 30%, about 35%, about 40%, about 45%, or about 50% by weight of the mixture.

For example, the carbon may have a surface area from about 100 m²/g to about 250 m²/g, about 100 m²/g to about 500 m²/g, about 100 m²/g to about 750 m²/g, about 100 m²/g to about 1000 m²/g, about 100 m²/g to about 1250 m²/g, about 100 m²/g to about 1500 m²/g, about 100 m²/g to about 1750 m²/g, about 100 m²/g to about 2000 m²/g, about 250 m²/g to about 2000 m²/g, about 500 m²/g to about 2000 m²/g, about 750 m²/g to about 2000 m²/g, about 1000 m²/g to about 2000 m²/g, about 1250 m²/g to about 2000 m²/g, about 1500 m²/g to about 2000 m²/g, about 1750 m²/g to about 2000 m²/g, or about 500 m²/g to about 1500 m²/g. As another example, the carbon may have a surface area of about 100 m²/g, about 200 m²/g, about 300 m²/g, about 400 m²/g, about 500 m²/g, about 600 m²/g, about 700 m²/g, about 800 m²/g, about 900 m²/g, about 1000 m²/g, about 1100 m²/g, about 1200 m²/g, about 1300 m²/g, about 1400 m²/g, about 1500 m²/g, about 1600 m²/g, about 1700 m²/g, about 1800 m²/g, about 1900 m²/g, or about 2000 m²/g.

The lubricant, when present, may be present in the mixture in an amount from about 1% to about 20% by weight. The lubricant contributes to the formation of the composite shell composition. The lubricant may comprise one or more layer-lattice lubricants such as molybdenum disulfide (MoS₂), tungsten disulfide (WS₂), titanium disulfide (TiS₂), graphite, graphene, boron nitride (BN), talc (magnesium silicate), or any combination thereof. The lubricant may comprise other inorganic solid lubricants such as MXenes. The lubricant may comprise oxide-based ceramic lubricants (e.g., alumina-zirconia composites), borates, silicates, polyphosphates, metal oxide nanoparticles, phosphates, or a combination thereof. The lubricant may comprise metal-based lubricants such as tin, lead, zinc, copper, or alloys thereof, or any combination thereof.

For example, the lubricant may be present in the mixture in an amount from about 1% to about 5%, about 1% to about 10%, about 1% to about 15%, about 1% to about 20%, about 5% to about 20%, about 10% to about 20%, about 15% to about 20%, or about 5% to about 15% by weight of the mixture. As another example, the lubricant may be present in the mixture in an amount of about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% by weight of the mixture.

The dry milling may be performed by any methods generally known in the art. Dry milling comprises milling the mixture in the absence of a solvent. The dry milling may be accomplished using a ball mill, autogenous mill, pebble mill, rod mill, buhrstone mill, SAG mill, tower mill, or other milling apparatuses known in the art. In an example, the dry milling is accomplished using a ball mill. In some embodiments, the milling may be conducted in an inert atmosphere, such as a nitrogen or argon atmosphere. In some embodiments, the milling may be conducted in a dry atmosphere, where the absolute humidity of the atmosphere is at or near zero.

The dry milling may occur for a duration of about 10 hours to about 30 hours. Over this time period, the dry milling may be conducted intermittently. For example, the dry milling may be accomplished by milling the mixture for 10 minutes, pausing the milling for 5 minutes, then resuming milling for 10 minutes, and repeating this pattern over the duration of the dry milling. This intermittent milling avoids overheating the mixture, which may cause the sulfur to melt or sublimate if temperatures increase too much.

In some embodiments, an additional particle size reduction step may occur after the dry milling process to break up agglomerates formed during the dry milling step. This may be accomplished by an additional dry milling step, a mortar and pestle, a grinder, a crusher, or another particle size reduction.

In some embodiments, a wet milling step may be conducted after the dry milling to remove any powder from the walls of the milling container. The solvent used during the wet milling is not particularly limited so long as it does not react with the components of the mixture. In some examples, the solvent may comprise a hydrocarbon solvent such as xylenes.

The process continues by heat treating the milled mixture. The heat treating melts the sulfur and allows it to diffuse into the carbon, thereby creating the composite shell compositions described in Section I. The heat treating may be conducted in any apparatus known in the art, such as a chem dryer or an oven. The heat treating may be conducted for a duration from about 2 hours to about 24 hours. The heat treatment may be conducted at a temperature from about 150° C. to about 170° C., such as from about 150° C. to about 155° C., about 150° C. to about 160° C., about 150° C. to about 165° C., about 155° C. to about 160° C., about 155° C. to about 165° C., about 155° C. to about 170° C., about 160° C. to about 165° C., about 160° C. to about 170° C., or about 165° C. to about 170° C.

After the heat treating, the mixture is cooled and the composite shell composition is recovered.

### III. Cathode Composition

Further provided herein are cathode compositions for use in the cathode layer of an electrochemical cell, such as in a solid electrochemical cell. The cathode compositions provided herein generally include a cathode active material and the composite shell composition described in Section I above. The cathode composition may be in the form of a cathode layer for use in an electrochemical cell or a cathode slurry for preparing a cathode layer of an electrochemical cell.

The composite shell composition may be present in the cathode composition in an amount from about 5% to about 60% by weight of the cathode composition. For example, the composite shell composition may be present in the cathode composition in an amount from about 5% to about 10%, about 5% to about 20%, about 5% to about 30%, about 5% to about 40%, about 5% to about 50%, about 5% to about 60%, about 10% to about 60%, about 20% to about 60%, about 30% to about 60%, about 40% to about 60%, about 50% to about 60%, about 10% to about 50%, about 20% to about 50%, or about 20% to about 40% by weight of the cathode composition. As another example, the composite shell composition may be present in the cathode composition in an amount of about 5%, about 6%, about 7%, about 8%, about 9%, about 10%, about 15%, about 20%, about 25%, about 30%, about 35%, about 40%, about 45%, about 50%, about 55%, or about 60% by weight of the cathode composition.

The cathode active material may include one or more of a coated or uncoated metal sulfide such as but not limited to molybdenum sulfide (MoS₂), iron sulfide (FeS, FeS₂, Fe₃S₄, Fe₁₋ₓS wherein x=0-0.2), copper sulfide (CuS, Cu₂S), titanium sulfide (TiS₂, TiS, Ti₂S₃), zinc sulfide (ZnS), tin sulfide (SnS, SnS₂), cobalt sulfide (CoS, CoS₂, Co₃S₄, Co₉S₈), nickel sulfide (Ni₃S₂, NiS₂, Ni₃S₄), lithium sulfide (Li₂S), lithium polysulfide (Li₂Sₓ wherein x=2-8), aluminum sulfide (Al₂S₃), vanadium sulfide (VS₄, VS₂), tungsten sulfide (WS₂), boron sulfide (B₂S₃), or any combination thereof. In still further embodiments, the cathode active material may comprise elemental sulfur (S). It should be noted that some of these materials may be included in the composite shell compositions; however, the cathode active material is distinct from the composite shell composition and does not form part of the composite shell composition.

The cathode active material may be present in the cathode composition in an amount from about 20% to about 95% by weight. For example, the cathode active material may be present in the cathode composition in an amount from about 20% to about 30%, about 20% to about 40%, about 20% to about 50%, about 20% to about 60%, about 20% to about 70%, about 20% to about 80%, about 20% to about 90%, about 20% to about 95%, about 30% to about 95%, about 40% to about 95%, about 50% to about 95%, about 60% to about 95%, about 70% to about 95%, about 80% to about 95%, or about 90% to about 95% by weight of the cathode composition. As another example, the cathode active material may be present in the cathode composition in an amount of about 20%, about 25%, about 30%, about 35%, about 40%, about 45%, about 50%, about 55%, about 60%, about 65%, about 70%, about 75%, about 80%, about 85%, about 90%, or about 95% by weight of the cathode composition.

The cathode composition may further include a solid electrolyte material. The solid electrolyte material may comprise an oxide, oxysulfide, sulfide, halide, nitride, or any other solid electrolyte known in the art. In some preferred embodiments, the solid electrolyte materials may comprise a sulfide solid electrolyte material, i.e., a solid electrolyte having at least one sulfur component. In some embodiments, the one or more solid electrolytes may comprise one or more material combinations such as Li₂S—P₂S₅, Li₂S—P₂S₅—LiI, Li₂S—P₂S₅—GeS₂, Li2_{S}-P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZmSn (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In). Halide solid electrolytes may have the structure Li-M-X, M is a metal element, and X is a halogen. These can be expressed by the generic formula Li_{α}M⁴⁺_{β}N³⁺_{(1-β)}X_{Ω}Y_{(6-Ω)}, where: 0≤β≤1; 0≤Ω≤6; α=6−[(β*4)+(1−β)*3]; X and Y are a halogen such as F, Cl, Br, I; M is an element with an oxidation state of 4+ such as Ti, Zr, Hf, and Rf; and N is an element an oxidation state of 3+ such as Ga, In, and Ti, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂.

In another embodiment, the solid electrolyte material may be one or more of a Li₃PS₄, Li₄P₂S₆, Li₂P₃S₁₁, Li₁₀GeP₂S₁₂, Li₁₀SnP₂S₁₂, Li₁₀SiP₂S₁₂. In a further embodiment, the solid electrolyte material may be one or more of a Li₆PS₅Cl, Li₆PS₅Br, Li₆PS₅I or expressed by the formula Li_{7-y}PS_{6-y}X_{y} where “X” represents at least one halogen and/or at least one pseudo-halogen, and where 0<y≤2.0 and where the halogen may be one or more of F, Cl, Br, I, and the pseudo-halogen may be one or more of N, NH, NH₂, NO, NO₂, BF₄, BH₄, AlH₄, CN, and SCN. In yet another embodiment, the solid electrolyte material be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, Cl, Br, I, and the pseudo-halogen may be one or more of N, NH, NH₂, NO, NO₂, BF₄, BH₄, AlH₄, CN, and SCN.

The solid electrolyte material may be present in the cathode composition in an amount from greater than 0% to about 60% by weight. For example, the solid electrolyte material may be present in the cathode composition in an amount from about 0% to about 10%, about 0% to about 20%, about 0% to about 30%, about 0% to about 40%, about 0% to about 50%, about 0% to about 60%, about 10% to about 60%, about 20% to about 60%, about 30% to about 60%, about 40% to about 60%, about 50% to about 60%, about 10% to about 50%, or about 20% to about 40% by weight of the cathode composition. As another example, the solid electrolyte material may be present in the cathode composition in an amount of about 1%, about 2%, about 3%, about 4%, about 5%, about 6%, about 7%, about 8%, about 9%, about 10%, about 15%, about 20%, about 25%, about 30%, about 35%, about 40%, about 45%, about 50%, about 55%, or about 60% by weight of the cathode composition.

The average particle size of the solid electrolyte material may be from about 100 nm to about 50 μm. In some aspects, the average particle size of the conductive additive may be about from 200 nm to about 40 μm, about 500 nm to about 30 μm, about 600 nm to about 30 μm, about 700 nm to about 25 μm, about 800 nm to about 20 μm, about 800 nm to about 15 μm, about 800 nm to about 15 μm, about 800 nm to about 10 μm, about 800 nm to about 9 μm, about 100 nm to about 10 μm, about 200 nm to about 10 μm, about 400 nm to about 10 μm, about 600 nm to about 10 μm, about 800 nm to about 10 μm, about 1 μm to about 10 μm, about 1.25 μm to about 10 μm, about 1.5 μm to about 10 μm, about 2 μm to about 10 μm, about 2.25 μm to about 9 μm, or about 2.5 μm to about 8 μm. In some embodiments, the solid-state electrolyte material may have a particle size of about 100 nm, 200 nm, 300 nm, 400 nm, 500 nm, 600 nm, 700 nm, 800 nm, 900 nm, 1 μm, 2 μm, 3 μm, 4 μm, 5 μm, 6 μm, 8 μm, 10 μm, 15 μm, 25 μm, or about 50 μm. The average particle size (e.g., D₅₀) may be determined through any method known to those having ordinary skill in the art.

The cathode composition may further include a binder. The binder may include fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVDF), polyhexafluoropropylene (PHFP), and polytetrafluoroethylene (PTFE), and binary copolymers such as copolymers of VdF and HFP such as poly(vinylene difluoride-hexafluoropropylene) copolymer (PVDF-HFP), and the like. In another embodiment, the binder may be one or more of a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, Poly (methacrylate) nitrile-butadiene rubber (PMMA-NBR) and the like. In a further embodiment, the binder may be one or more of an acrylic resin such as but not limited to polymethyl (meth) acrylate, polyethyl (meth) acrylate, polyisopropyl (meth) acrylate polyisobutyl (meth) acrylate, polybutyl (meth)acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), and mixtures thereof.

The cathode composition may further include a conductive additive. The conductive additive helps to evenly distribute the charge density throughout the anode. The conductive additive may include metal powders, fibers, filaments, or any other material known to conduct electrons. The conductive additive may comprise a carbon-based conductive additive, such as carbon fiber, graphite, graphene, conductive carbon, amorphous carbon, vapor grown carbon fiber (VGCF), carbon nanotubes, carbon nanowires, activated carbon, and combinations thereof.

The conductive additive may be present in the cathode composition in an amount from about 0% to about 40% by weight. For example, the conductive additive may be present in the cathode composition in an amount from about 0% to about 10%, about 0% to about 20%, about 0% to about 30%, about 0% to about 40%, about 10% to about 40%, about 20% to about 40%, about 30% to about 40%, about 10% to about 20%, about 10% to about 30%, or about 20% to about 30% by weight of the cathode composition. As another example, the conductive additive may be present in the cathode composition in an amount from about 0%, about 1%, about 2%, about 3%, about 4%, about 5%, about 6%, about 7%, about 8%, about 9%, about 10%, about 15%, about 20%, about 25%, about 30%, about 35%, or about 40% by weight of the cathode composition.

The average particle size of the conductive additive may be from about 5 nm to about 1000 nm. In some aspects, the average particle size of the conductive additive may be about from 5 nm to about 100 nm, about 5 nm to about 200 nm, about 5 nm to about 300 nm, about 5 nm to about 400 nm, about 5 nm to about 500 nm, about 5 nm to about 600 nm, about 5 nm to about 700 nm, about 5 nm to about 800 nm, about 5 nm to about 900 nm, about 100 nm to about 1000 nm, about 200 nm to about 1000 nm, about 300 nm to about 1000 nm, about 400 nm to about 1000 nm, about 500 nm to about 1000 nm, about 600 nm to about 1000 nm, about 700 nm to about 1000 nm, about 800 nm to about 1000 nm, about 900 nm to about 1000 nm, about 100 nm to about 500 nm, or about 200 nm to about 400 nm. In some embodiments, the conductive additive may have a particle size of about 5 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, or about 1000 nm. In some examples, the conductive additive may have an average particle size of about 30 nm. The average particle size (e.g., D₅₀) may be determined through any method known to those having ordinary skill in the art.

### Enumerated Embodiments

Embodiment 1: A composite shell comprising sulfur, carbon, and a lubricant, the composite shell having an average diameter from about 1 micron to about 50 microns and a substantially spheroidal shape.

Embodiment 2: The composite shell of embodiment 1, wherein the composite shell lacks a core.

Embodiment 3: The composite shell of embodiment 1, wherein the composite shell defines a void inside of the composite shell.

Embodiment 4: The composite shell of any one of embodiments 1-3, wherein the lubricant comprises molybdenum disulfide, titanium disulfide, tungsten disulfide, graphite, graphene, boron nitride, talc, or a combination thereof.

Embodiment 5: The composite shell of any one of embodiments 1-4, wherein the sulfur comprises elemental sulfur.

Embodiment 6: The composite shell of any one of embodiments 1-5, wherein the carbon comprises carbon black.

Embodiment 7: The composite shell of any one of embodiments 1-6, wherein the lubricant is present in the composite shell in a concentration from about 1% to about 20% by weight.

Embodiment 8: The composite shell of any one of embodiments 1-7, wherein the sulfur is present in the composite shell in a concentration from about 40% to about 90% by weight.

Embodiment 9: The composite shell of any one of embodiments 1-8, wherein the carbon is present in the composite shell in a concentration from about 5% to about 50% by weight.

Embodiment 10: The composite shell of any one of embodiments 1-9, wherein the composite shell does not comprise a binder.

Embodiment 11: The composite shell of any one of embodiments 1-10, wherein the carbon has a surface area from about 100 m²/g to about 2000 m²/g.

Embodiment 12: A composite shell comprising sulfur and carbon, the composite shell having an average diameter from about 1 micron to about 50 microns and a substantially spheroidal shape.

Embodiment 13: A cathode composition for use in a solid electrochemical cell, the cathode comprising:
a cathode active material; and
a composite shell comprising sulfur, carbon, and a lubricant having an average diameter from about 1 micron to about 50 microns, the composite shell having a substantially spheroidal shape.

Embodiment 14: The cathode composition of embodiment 13, further comprising a solid electrolyte material.

Embodiment 15: The cathode composition of embodiment 13 or 14, further comprising a binder.

Embodiment 16: The cathode composition of any one of embodiments 13-15, wherein the cathode active material comprises pyrite.

Embodiment 17: A process for making a composite shell composition, the process comprising:
dry milling a mixture comprising sulfur, carbon, and a lubricant; and
heat treating the mixture at a temperature from about 150° C. to about 170° C. to form the composite shell composition.

Embodiment 18: The process of embodiment 17, wherein the dry milling is performed intermittently for a duration of from about 10 hours to about 30 hours.

Embodiment 19: The process of embodiment 17 or 18, wherein the heat treating is conducted for a duration from about 2 hours to about 24 hours.

Embodiment 20: The process of any one of embodiments 17-19, wherein the heat treating is conducted in an inert atmosphere.

Embodiment 21: The process of any one of embodiments 17-20, further comprising a wet milling step prior to the heat treating step.

Embodiment 22: The process of any one of embodiments 17-21, wherein the composite shell composition has an average diameter from about 1 micron to about 50 microns and a substantially spheroidal shape.

Embodiment 23: The process of any one of embodiments 17-22, wherein the composite shell lacks a core.

Embodiment 24: The process of any one of embodiments 17-23, wherein the lubricant comprises molybdenum sulfide, titanium sulfide, graphite, boron nitride, or a combination thereof.

Embodiment 25: The process of any one of embodiments 17-24, wherein the sulfur comprises elemental sulfur.

Embodiment 26: The process of any one of embodiments 17-25, wherein the carbon comprises carbon black.

Embodiment 27: The process of any one of embodiments 17-26, wherein the lubricant is present in the mixture a concentration from about 1% to about 20% by weight.

Embodiment 28: The process of any one of embodiments 17-27, wherein the sulfur is present in the mixture in a concentration from about 40% to about 90% by weight.

Embodiment 29: The process of any one of embodiments 17-28, wherein the carbon is present in the mixture in a concentration from about 5% to about 50% by weight.

### EXAMPLES

Examples have been set forth below for the purpose of illustration and to describe certain specific embodiments of the disclosure. However, the scope of the claims is not to be in any way limited by the examples set forth herein. Various changes and modifications to the disclosed embodiments will be apparent to those skilled in the art and such changes and modifications including, without limitation, those relating to the chemical structures, substituents, derivatives, formulations, or methods of the disclosure may be made without departing from the spirit of the disclosure and the scope of the appended claims. Definitions of the variables in the structures in the schemes herein are commensurate with those of corresponding positions in the formulae presented herein.

### Example 1

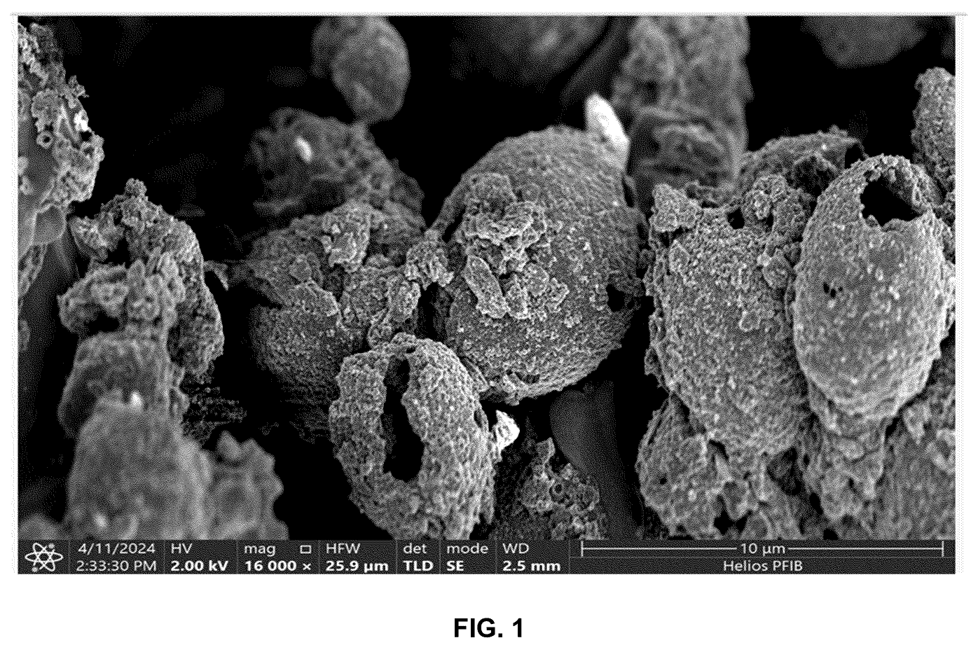

Elemental sulfur, carbon black having a surface area ranging from 1400-1600 m²/g, and molybdenum sulfide (MoS₂) were ball milled for 20 hours at 400 rpm. Zirconia balls were used as the milling media. The milling was performed intermittently for 10 minutes on/5 minutes off to prevent the mixture from heating up. The powder was then removed from the milling jar. The particles had a diameter from about 2 mm to about 5 mm. The jar was then briefly wet milled with xylene to remove any remaining powder from the sides of the jar; however, the lubrication properties of the molybdenum sulfide prevented much of the powder from adhering to the sides of the jar. The powder was then heat treated at 160° C. for 15 hours in a chem dryer. The resulting material was then imaged using scanning electron microscopy, shown in FIG. 1. The image shows the formation of composite shells of the composite material. The composite was then combined with FeS₂, a solid electrolyte material, and a binder to form a cathode layer.

### Example 2

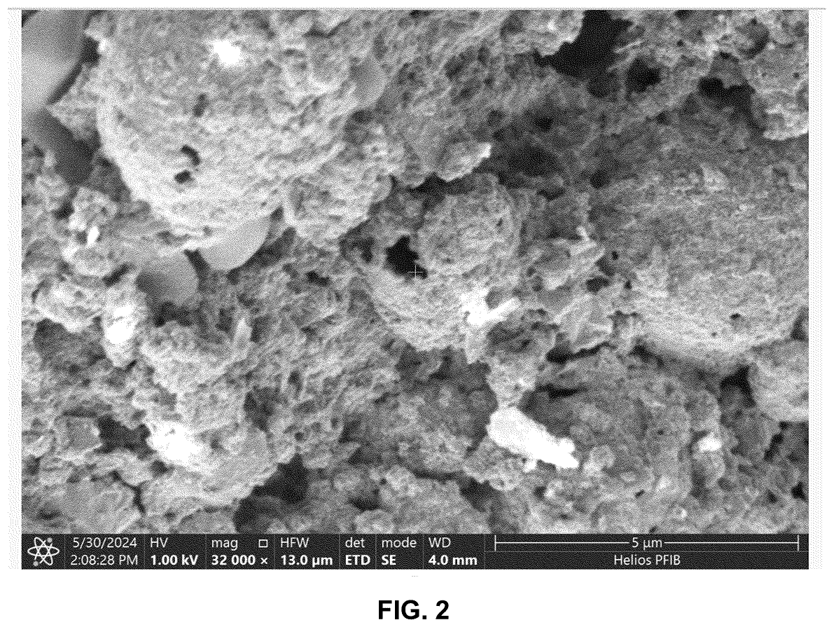

The materials used in Example 2 were the same as in Example 1, except that the MoS₂ was replaced with graphite. Some small composite shell structures were formed. The composite shells produced in Example 2 are shown in FIG. 2.

### Example 3

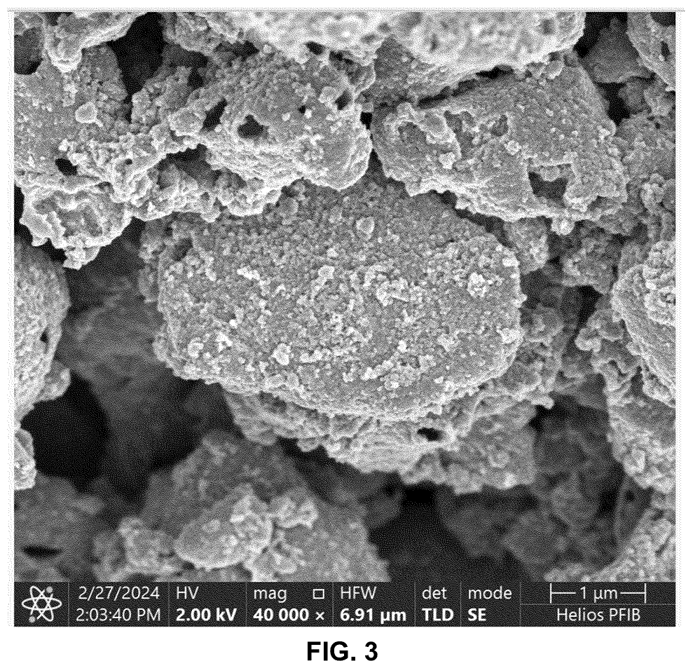

The materials used in Example 3 were the same as in Example 1, except that the MoS₂ was replaced with carbon black. The carbon black had a surface area ranging from 1400-1600 m²/g. Some small composite shell structures were formed. The composite shells produced in Example 3 are shown in FIG. 3.

### Comparative Example 1

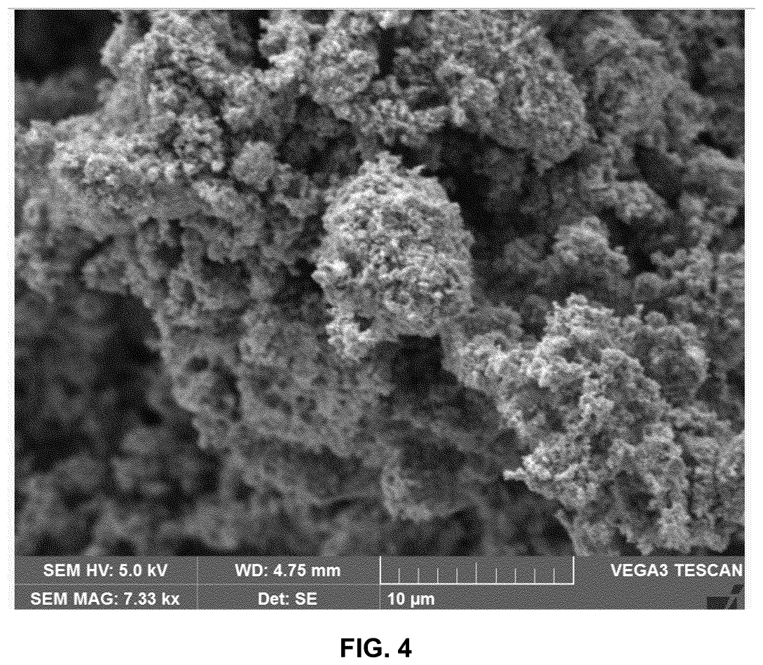

The materials used in Comparative Example 1 were the same as in Example 1 except no MoS₂ was added. Accordingly, the composition prepared did not include the composite shells of the present disclosure. The processing steps and cathode formation were identical to that of Example 1. The composite made in Comparative Example 1 is shown in FIG. 4.

Table 1 shows the cycling data of the electrochemical cells made using the cathode composite of Comparative Example 1 and the cathode composite of Example 1. Comparing these results, the cathode composite of Example 1, which contains a cathode composite made with the composite spheres of the present disclosure, had an initial discharge capacity that is 93% higher than the cell made without the composite shells in the cathode. After 7 cycles, the discharge capacity of Example 1 was still 30% higher than that of Comparative Example 1. From this comparison, it is shown that using a cathode composite containing the composite shells described herein produces an electrochemical cell with a high initial discharge capacity and a high overall capacity.

TABLE 1

| | Example 1 | Comp. Example 1 |
|---|---|---|
| Cycle # | Discharge Capacity (mAh/g) | Discharge Capacity (mAh/g) |
| 1 | 464 | 240 |
| 2 | 612 | 427 |
| 3 | 635 | 458 |
| 4 | 648 | 467 |
| 5 | 608 | 473 |
| 6 | 645 | 478 |
| 7 | 630 | 482 |

### Comparative Example 2

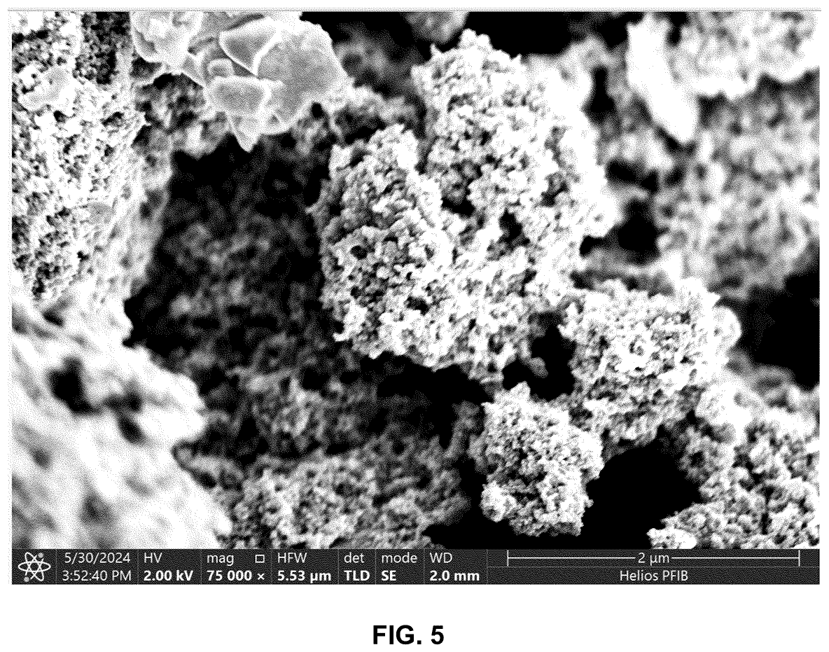

The materials used in Comparative Example 2 were the same as in Example 1 except that the dry milling process was replaced with a wet milling process. Xylenes were used as the solvent for the wet milling process. The composite made in Comparative Example 2 is shown in FIG. 5. No composite shell structures were observed.

What is claimed is:

1. A composite shell comprising sulfur, carbon, and a lubricant, the composite shell having an average diameter from about 1 micron to about 50 microns and a substantially spheroidal shape.

2. The composite shell of claim 1, wherein the composite shell lacks a core.

3. The composite shell of claim 1, wherein the composite shell defines a void inside of the composite shell.

4. The composite shell of claim 1, wherein the lubricant comprises molybdenum disulfide, titanium disulfide, tungsten disulfide, graphite, graphene, boron nitride, talc, or a combination thereof.

5. The composite shell of claim 1, wherein the sulfur comprises elemental sulfur.

6. The composite shell of claim 1, wherein the carbon comprises carbon black.

7. The composite shell of claim 1, wherein the lubricant is present in the composite shell in a concentration from about 1% to about 20% by weight.

8. The composite shell of claim 1, wherein the sulfur is present in the composite shell in a concentration from about 40% to about 90% by weight.

9. The composite shell of claim 1, wherein the carbon is present in the composite shell in a concentration from about 5% to about 50% by weight.

10. The composite shell of claim 1, wherein the composite shell does not comprise a binder.

11. The composite shell of claim 1, wherein the carbon has a surface area from about 100 m²/g to about 2000 m²/g.

12. A composite shell comprising sulfur and carbon, the composite shell having an average diameter from about 1 micron to about 50 microns and a substantially spheroidal shape.

13. A cathode composition for use in a solid electrochemical cell, the cathode comprising:
a cathode active material; and
a composite shell comprising sulfur, carbon, and a lubricant having an average diameter from about 1 micron to about 50 microns, the composite shell having a substantially spheroidal shape.

14. The cathode composition of claim 13, further comprising a solid electrolyte material.

15. The cathode composition of claim 13, further comprising a binder.

16. The cathode composition of claim 13, wherein the cathode active material comprises pyrite.

17. A process for making a composite shell composition, the process comprising:
dry milling a mixture comprising sulfur, carbon, and a lubricant; and
heat treating the mixture at a temperature from about 150° C. to about 170° C. to form the composite shell composition.

18. The process of claim 17, wherein the dry milling is performed intermittently for a duration of from about 10 hours to about 30 hours.

19. The process of claim 17, wherein the heat treating is conducted for a duration from about 2 hours to about 24 hours.

20. The process of claim 17, wherein the heat treating is conducted in an inert atmosphere.

21. The process of claim 17, further comprising a wet milling step prior to the heat treating step.

22. The process of claim 17, wherein the composite shell composition has an average diameter from about 1 micron to about 50 microns and a substantially spheroidal shape.

23. The process of claim 17, wherein the composite shell lacks a core.

24. The process of claim 17, wherein the lubricant comprises molybdenum sulfide, titanium sulfide, graphite, boron nitride, or a combination thereof.

25. The process of claim 17, wherein the sulfur comprises elemental sulfur.

26. The process of claim 17, wherein the carbon comprises carbon black.

27. The process of claim 17, wherein the lubricant is present in the mixture a concentration from about 1% to about 20% by weight.

28. The process of claim 17, wherein the sulfur is present in the mixture in a concentration from about 40% to about 90% by weight.

29. The process of claim 17, wherein the carbon is present in the mixture in a concentration from about 5% to about 50% by weight.
